(19) United States
(12) Patent Application Publication
(10) Pub. No.: US 2026/0349454 A1
(43) Pub. Date: Nov. 5, 2026

(54) PUMP SYSTEM FOR SLIDING GLASS DOOR TRACKS

(71) Applicant: STORM ARMOUR, INC., Miami Beach, FL (US)

(72) Inventors: Mark Fisher, Bal Harbour, FL (US); Todd Michael Glaser, Palm Beach, FL (US); Ronald Simkins, Miami, FL (US); David Kreps, Miami Beach, FL (US); Werner Blumenthal, Miami, FL (US)

(73) Assignee: STORM ARMOUR, INC., Miami Beach, FL (US)

(21) Appl. No.: 19/664,564

(22) Filed: Apr. 30, 2026

Related U.S. Application Data
(60) Provisional application No. 63/797,796, filed on Apr. 30, 2025.
(60) Provisional application No. 63/797,792, filed on Apr. 30, 2025.

(51) Int. Cl. G05D 9/12; E06B 7/14

(52) U.S. Cl. CPC G05D 9/12; E06B 7/14

(57) ABSTRACT

A system for removing water from a track of a sliding door or window includes a pump, a water level sensor positioned within the track, an inlet hose coupling the track to the pump, and an outlet hose configured to discharge water to an exterior location. The sensor activates the pump in response to a detected water level. One or more flow control elements restrict reverse flow.

### CROSS-REFERENCE TO RELATED APPLICATIONS

This application claims the benefit of U.S. Provisional Application No. 63/797,792 and U.S. Provisional Application No. 63/797,796, each filed Apr. 30, 2025, the disclosures of which are hereby incorporated by reference in their entirety.

### FIELD

The present invention relates generally to water intrusion management devices and systems, and more particularly, to automatic water removal systems specifically adapted for use with sliding glass doors in residential structures, including high-rise condominiums, townhouses, apartments, and single-family homes.

### BACKGROUND

Sliding glass doors installed in residential dwellings typically incorporate bottom tracks equipped with weep holes designed to drain accumulated water. Under normal rainfall conditions, these weep holes effectively allow for water drainage. However, during severe weather events involving wind-driven rain, the weep holes fail to adequately drain water, resulting in water accumulation within the sliding door tracks. This accumulation may become severe enough to overflow the tracks and sill, leading to water intrusion into interior living spaces. Existing water management solutions do not offer automatic or efficient removal systems capable of mitigating this problem effectively. There exists a clear need for an automated, reliable, and homeowner-friendly system that actively monitors and removes accumulated water from sliding glass door tracks.

### SUMMARY OF THE INVENTION

The present invention provides an automatic water removal system specifically designed to prevent water accumulation and intrusion from sliding glass door tracks. The system comprises an electric water pump, a removable water level sensor, inlet and outlet hoses equipped with check valves, and optionally incorporates a splash guard as an additional protective element.

In a preferred embodiment of the disclosure, a system for automatically removing water accumulated within the tracks of sliding glass doors is described, the system comprising: a pump adapted for connection to an electrical power source and including battery backup capability; a water level sensor configured for placement within the sliding glass door tracks; an inlet hose fluidly connecting the water level sensor to the pump; an outlet hose fluidly connected to the pump and adapted to discharge water externally; at least one check valve positioned within the hoses to ensure unidirectional flow away from the interior; and a splash guard disposed along the interior side of the sliding glass door sill and frame, forming a secondary barrier against water intrusion.

In one aspect, a system includes a pump, a water level sensor configured for placement within a track, an inlet hose fluidly coupling the track to the pump, and an outlet hose configured to discharge water to an exterior location. One or more flow control elements are disposed within the hoses to restrict reverse flow.

In another aspect, the system is configured such that the sensor activates the pump upon detection of a predetermined water level within the track.

In another aspect, the system includes a routing configuration in which the outlet hose passes through a structure via a sealed opening.

The construction and method of operation and installation of the invention and additional objects and advantages of the invention are best understood from the following description of specific embodiments when read in connection with the accompanying drawings.

### BRIEF DESCRIPTION OF THE DRAWINGS

The drawings illustrate embodiments of the system.

FIG. 1 is an isometric view of a sliding door assembly showing the system installed;

FIG. 2 is a front view of the system;

FIG. 3 is a top view of a track showing sensor placement;

FIG. 4 is an isometric view of a system according to an embodiment, installed in a sliding door track;

FIG. 5 is detailed view of FIG. 4;

FIG. 6 is a detailed view of FIG. 4;

FIG. 7 is a detailed view of FIG. 4;

FIG. 8 is a partial front view;

FIG. 9 is a partial sectional view of FIG. 8;

FIG. 10 is a detailed view of FIG. 9;

FIG. 11 is a partial top view of FIG. 8;

FIG. 12 is a partial sectional view of FIG. 11;

FIG. 13 is an exploded view according to an embodiment;

FIG. 14 is an unexploded view of FIG. 13;

FIG. 15 is a bottom isometric view according to an embodiment;

FIG. 16 is a detailed view of FIG. 15;

FIG. 17 is an isometric view according to an embodiment;

FIG. 18 is a detailed view of FIG. 17;

FIG. 19 is a front view according to an embodiment;

FIG. 20 is a detailed view of FIG. 19 showing the pump in an installed state; and

FIG. 21 shows the pump of FIG. 20 in a detached state.

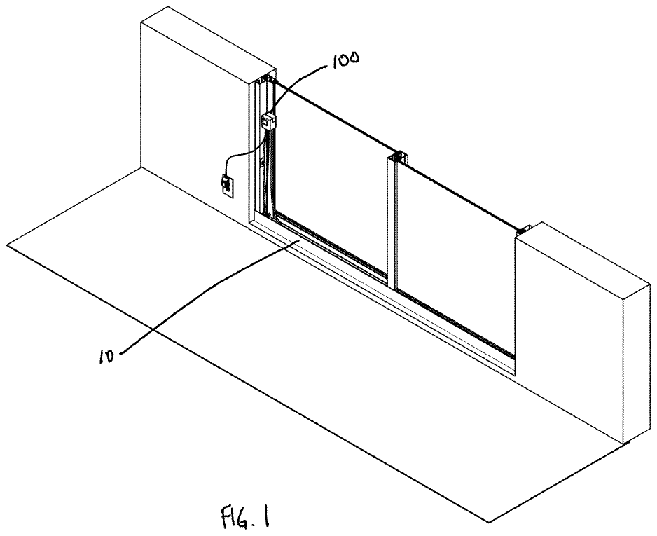

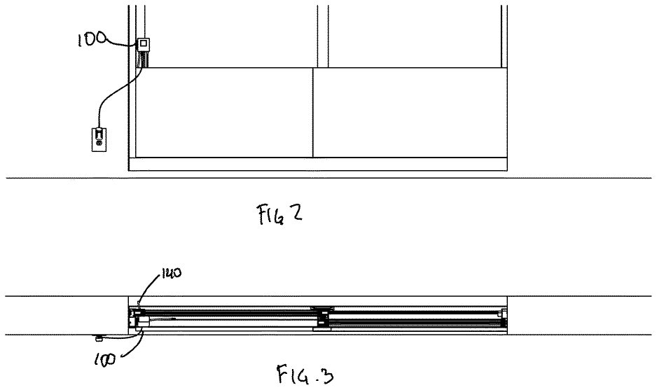

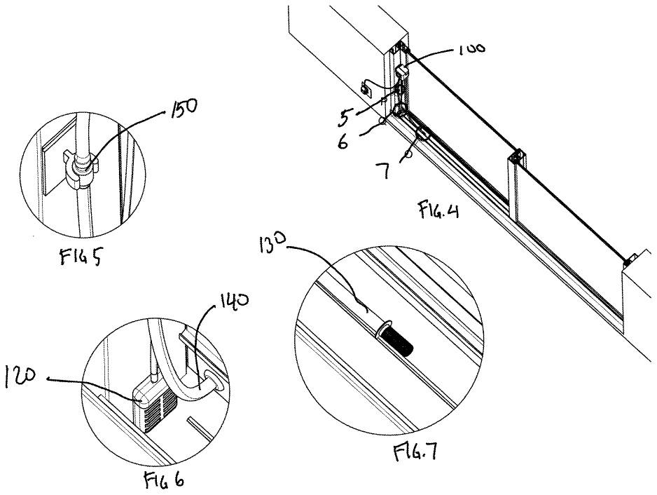

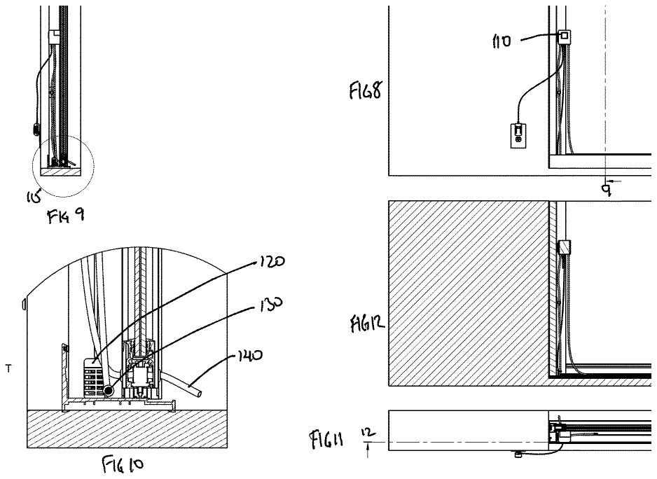

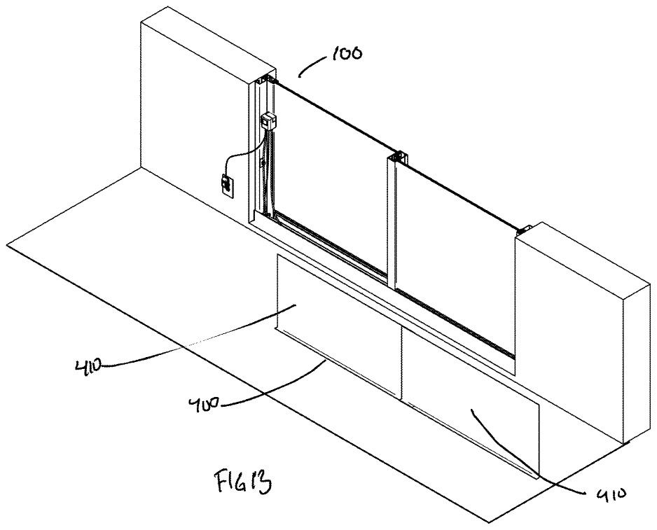

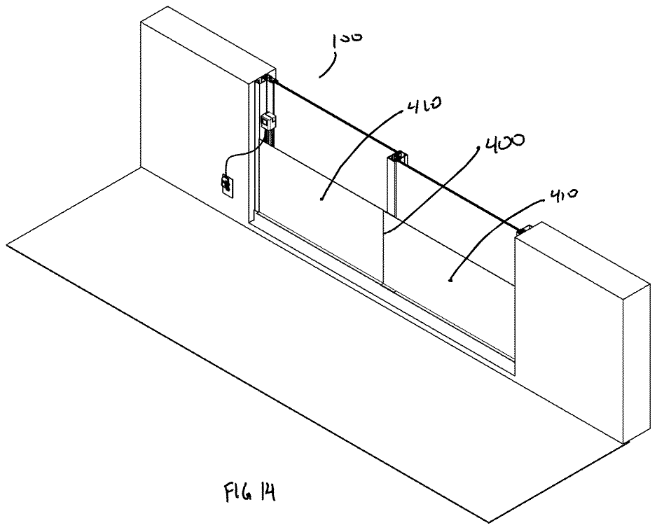

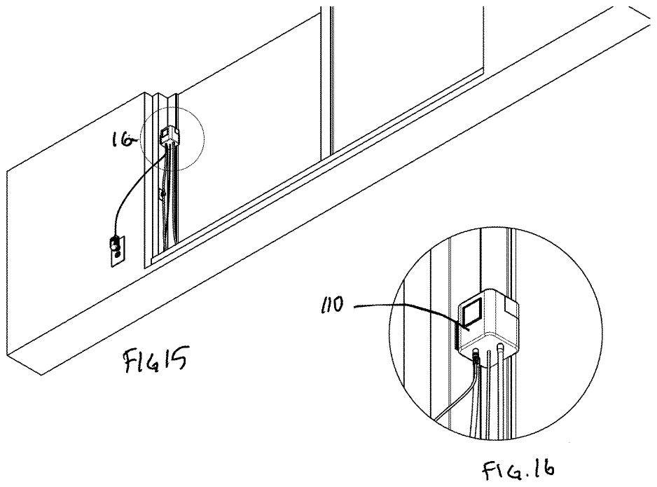

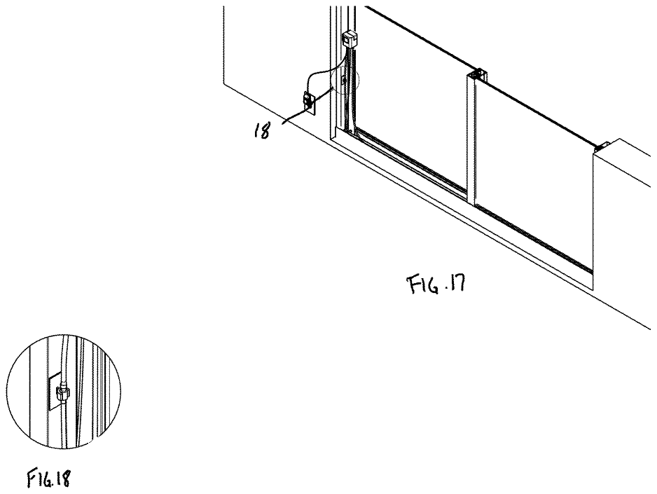

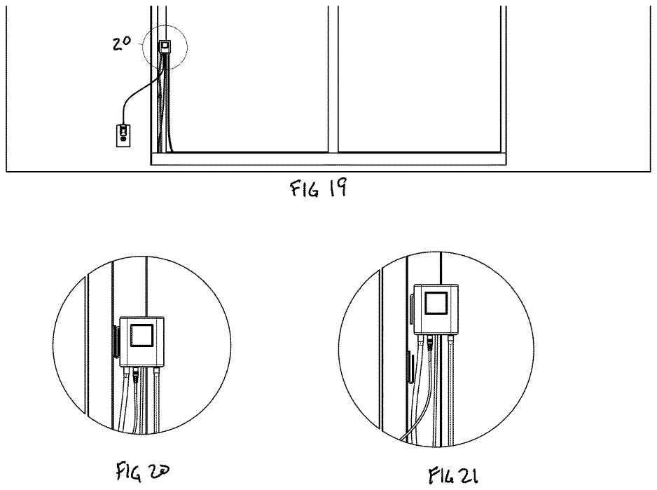

### DETAILED DESCRIPTION

The invention addresses severe weather-related water intrusion by providing an automated, efficient, and simple-to-install system. The primary component of the invention is a compact, electrically powered water pump designed to remove water that accumulates within the tracks of sliding glass doors. The pump is electrically powered via a standard residential power outlet and includes a battery backup feature ensuring continuous operation during power outages, a common occurrence during severe weather events.

A removable water level sensor is positioned within the sliding glass door tracks at the lowest point where water tends to accumulate. When the water reaches a predetermined level, the sensor triggers the pump to activate. The sensor is designed for easy placement and removal, allowing homeowners to position it optimally based on the specific track profile and typical accumulation points.

The inlet hose connects the water sensor area to the pump inlet, facilitating water removal from the track. The outlet hose is connected to the pump outlet and extends from the interior to the exterior through a small, grommet-lined hole drilled through the base of the sliding glass door frame. This simple and minimal modification to the door assembly maintains structural integrity and weatherproofing. The hoses incorporate check valves designed to prevent backflow, ensuring water flows exclusively outward from the interior space.

The system optionally includes a splash guard barrier, comprising a semi-rigid, waterproof panel featuring compliant adhesive foam strips and a “living hinge” allowing secure adhesion to the sliding door sill and frame. The splash guard serves as a secondary barrier, effectively managing excess water during extreme conditions and further protecting the interior living space.

Installation of the system is straightforward and does not require extensive technical knowledge or permanent structural modifications. The homeowner positions the water level sensor within the track, mounts the pump discretely along the door side or frame, and routes the inlet and outlet hoses accordingly. The minimal frame modification (a drilled hole with grommets) accommodates the hoses without compromising door functionality or aesthetic integrity.

Further embodiments of the disclosure uniquely combines active water removal via a reliable pump and sensor system with a passive protective barrier (splash guard) to comprehensively manage water intrusion. Thus, it provides homeowners with a highly effective, automated, and user-friendly solution to prevent water damage from sliding glass door assemblies during severe weather conditions.

### Overall System

A water removal system 100 is configured to remove water accumulated within a track 10 of a sliding door or window assembly. The system includes a pump 110, a water level sensor 120, an inlet hose 130, an outlet hose 140, and one or more flow control elements 150.

### Pump

The pump 110 is configured to draw water from the track and discharge the water to an exterior location. The pump may be electrically powered and, in some embodiments, includes a backup power source.

### Water Level Sensor

The water level sensor 120 is configured for placement within the track 10 at a location where water accumulates. The sensor detects a water level and generates a signal to activate the pump when the water level reaches a predetermined threshold. The sensor may be removable and repositionable.

### Inlet Hose

The inlet hose 130 fluidly couples the track 10 to the pump 110. The inlet hose is positioned to draw water from within the track.

### Outlet Hose

The outlet hose 140 is fluidly coupled to the pump 110 and configured to discharge water away from the interior. The outlet hose may extend through an opening formed in a structural component, such as a door frame, and may be routed to an exterior location.

### Flow Control Elements

One or more flow control elements 150 are disposed within the inlet hose 130 and/or outlet hose 140. The flow control elements are configured to permit flow in a direction away from the track and to restrict reverse flow.

### Installation

The sensor 120 is placed within the track. The pump 110 is positioned adjacent to the door or frame. The inlet and outlet hoses are connected accordingly. In some embodiments, the outlet hose passes through a sealed opening formed in the structure.

### Operation

When water accumulates within the track and reaches a threshold level, the sensor activates the pump. The pump draws water through the inlet hose and discharges it through the outlet hose. The flow control elements prevent backflow.

### System Integration

The system may be used independently or in combination with a barrier system 400. Where the barrier system 400 includes one or more panels 410 that are configured with a sealing surface 420 in order to create a sealed barrier, effectively raising the track sill wall height.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the disclosure. In particular, features from one embodiment can be used with another embodiment. The embodiments were chosen and described to best explain the principles of the disclosure and the practical application, and to enable others of ordinary skill in the art to understand the invention for various embodiments with various modifications as are suited to the particular use contemplated.

Drawing figures are concurrently filed herewith and form part of the present disclosure.

1. A system for removing water from a track of a sliding door or window assembly, comprising:
a pump;
a water level sensor configured for placement within the track;
an inlet hose fluidly coupling the track to the pump;
an outlet hose fluidly coupled to the pump and configured to discharge water away from the track; and
at least one flow control element configured to restrict reverse flow,
wherein the sensor is configured to activate the pump in response to detection of a predetermined water level within the track.

2. The system of claim 1, wherein the sensor is positioned at a lowest point within the track.

3. The system of claim 1, wherein the pump is electrically powered.

4. The system of claim 1, wherein the pump includes a backup power source.

5. The system of claim 1, wherein the outlet hose extends through an opening in a structural component.

6. The system of claim 5, wherein the opening includes a sealing element.

7. The system of claim 1, wherein the sensor is removable.

8. The system of claim 1, wherein the flow control element comprises a check valve.

9. The system of claim 1, wherein the system is configured for installation without permanent structural modification other than formation of an opening for the outlet hose.

10. A method of removing water from a track, comprising:
placing a water level sensor within the track;
fluidly coupling the track to a pump via an inlet hose;
routing an outlet hose from the pump to an exterior location;
detecting a water level within the track; and
activating the pump to remove water when the water level exceeds a threshold.
